(19) United States
(12) Patent Application Publication
(10) Pub. No.: US 2024/0392737 A1
(43) Pub. Date: Nov. 28, 2024

(54) FILTER ELEMENT FOR LIQUID FILTRATION AND FILTER

(71) Applicant: ZHEJIANG WEITAI AUTOMOBILE PARTS CO., LTD., Huzhou City (CN)

(72) Inventors: JIAN-BIN CHENG, Huzhou City (CN); YU ZHANG, Huzhou City (CN); XIAO-WEI YING, Huzhou City (CN); QING-LIN DENG, Huzhou City (CN); SHI-XIAN LAN, Huzhou City (CN)

(21) Appl. No.: 18/668,103

(22) Filed: May 17, 2024

(30) Foreign Application Priority Data
May 26, 2023 (CN) 202310606552.6

(51) Int. Cl. F02M 37/34; F02M 37/24; F02M 37/42

(52) U.S. Cl. CPC F02M 37/34; F02M 37/24; F02M 37/42

(57) ABSTRACT

Disclosed are a filter element for liquid filtration and a filter. The filter element includes a ring filter medium, first and second end caps connected to the ring filter medium, and a ventilation assembly, where the ring filter medium has a central cavity formed around a central axis thereof; the ventilation assembly is disposed in the central cavity; and an intercepting ring groove is formed at a ring seal. In this technical solution, a sealing O-ring at a sealing part of the filter element and the housing assembly is replaced with the ring seal with a self-sealing function, which has a better sealing effect under an oil pressure and can reduce a compression amount; and while oil dirt is intercepted, the disassembly of the filter element is not affected, and especially under effective exhaust of the ventilation assembly, the disassembly is more labor-saving.

### CROSS REFERENCE TO RELATED APPLICATIONS

The present application claims priority from China Patent Application No. 202310606552.6, filed May 26, 2023, whose disclosure is incorporated by reference in its entirety herein.

### BACKGROUND OF THE INVENTION

### Field of the Invention

The present disclosure relates to the technical field of filters, in particular to a filter element for liquid filtration and a filter.

### Description of Related Art

A fuel filter functions to filter fuel (gasoline or diesel) required for the combustion in an engine to prevent foreign matter such as dust, metal powder, moisture, and organic matter in the fuel from entering the engine to cause engine wear or blockage of a fuel supply system. During operation of an engine, fuel is delivered to a nozzle by a fuel supply system. There is a high negative pressure at the front end of a fuel pump. Under the action of the negative pressure, air dissolved in fuel will overflow, and air may also be sucked into a fuel delivery pipeline and connectors due to poor sealing. After the fuel is heated, fuel vapor will also be produced due to evaporation of water dissolved in the fuel. During mounting and maintenance of a filter, the air will also be mixed into the pipeline. If these gases are not exhausted in time, unstable fuel supply in the fuel supply system, abnormal output power or even stalling and other problems of the engine, and safety accidents will be resulted.

In the patent of a liquid medium filter element with ventilation assemblies on a rear filtering side and a front filtering side, and a filter system (publication number: CN106975267A), a first ventilation channel fluidly connected to the front filtering side at an inlet end and a second ventilation channel fluidly connected to the rear filtering side at the inlet end are disclosed. In actual use, because an opening of the first ventilation channel is too large, uncleaned oil easily enters the first ventilation channel, resulting in degradation of the filtering performance; the second ventilation channel is bent and thus is easy to block by the oil, such that air on a clean side cannot be effectively discharged. Moreover, a sealing O-ring is used in the filter element. In order to enhance the sealing effect, a large amount of compression is generally adopted for interference fit. Meanwhile, oil dirt and impurities after oil filtration are settled at the sealing O-ring. Due to slurry settlement caused by long-time operation and compression for interference fit, the filter element is difficult to disassemble when replaced, and especially when the ventilation channel is not smooth, an internal negative pressure is formed during disassembly, such that the disassembly requires a larger force and is more laborious.

### BRIEF SUMMARY OF THE INVENTION

A main objective of the present disclosure is to propose a filter element for liquid filtration and a filter, aiming to solve the technical problem that a current filter is difficult to disassemble due to blockage of a sealing ring when a filter element is replaced.

To achieve the above objective, the filter element for liquid filtration proposed by the present disclosure includes:
a ring filter medium, and a first end cap and a second end cap connected to the ring filter medium, where the ring filter medium has a central cavity formed around a central axis thereof;
a ventilation assembly disposed in the central cavity and having a first ventilation hole communicated to an exhaust pipeline from a clean side and a second ventilation hole communicated to the exhaust pipeline from a non-clean side; and
a ring seal including a first sealing portion and a second sealing portion which are hermetically connected to the second end cap and a housing assembly respectively, where an intercepting ring groove is formed at a joint between the first sealing portion and the second sealing portion.

Optionally, the ventilation assembly includes a connector connected to the first end cap and a tubular body communicated to the exhaust pipeline in the housing assembly, where the connector is communicated with the tubular body.

Optionally, the first ventilation hole is formed in the connector or the tubular body.

Optionally, a ventilation channel is formed at a joint between the tubular body and the connector.

Optionally, the second ventilation hole is formed in the first end cap or the connector.

Optionally, a middle of the first end cap axially protrudes outward to form an annular protrusion, the connector is hermetically connected to an inner wall of the annular protrusion, and the second ventilation hole is formed in the connector.

Optionally, a middle of the first end cap axially protrudes outward to form an annular protrusion, an inner sidewall of the annular protrusion axially extends inward to form a closed end, and the second ventilation hole is formed in the closed end.

Optionally, a central frame is further included, where the central frame is disposed in the central cavity and at a periphery of the ventilation assembly, and an oil-water separation medium is circumferentially distributed on the central frame; and
a flow guide plate distributed in a spiral shape is disposed on a peripheral edge of the central frame.

Optionally, a buckle is disposed on an end surface of the first end cap, and the buckle is in clamped connection with a locking piece in a screw cap of a filter.

The present disclosure further provides a filter, including: the above filter element for liquid filtration; and
a housing assembly, where a central tube is disposed inside the housing assembly, and the ventilation assembly is communicated with the central tube till an exhaust pipeline.

In the technical solution of the present disclosure, air gathered on the clean side and the non-clean side of the filter element passes through the first ventilation hole and the second ventilation hole of the ventilation assembly respectively and is discharged into the exhaust pipeline in the housing assembly of the filter by the ventilation assembly. The designed small holes can enable the air to smoothly pass through and allow a very small amount of oil to pass through, are hard to block, and will not degrade the filtering performance of the filter element. In addition, a scaling O-ring at a sealing part of the filter element and the housing assembly is replaced with the ring seal with a self-sealing function, which has a better sealing effect under a pressure difference and can reduce a compression amount; and the intercepting ring groove is hard to block by oil dirt while settling the oil dirt, the replacement and disassembly of the filter element are not affected, and especially under effective exhaust of the ventilation assembly, the disassembly is more labor-saving.

### BRIEF DESCRIPTION OF THE DRAWINGS

To more clearly illustrate the embodiments of the present disclosure or the technical solutions in the prior art, the accompanying drawings that need to be used in the description of the embodiments or the prior art will be briefly introduced below. Apparently, the accompanying drawings in the description below merely illustrate some embodiments of the present disclosure. Those of ordinary skill in the art may also derive other accompanying drawings from structures shown in these accompanying drawings without creative efforts.

FIG. 1 is a sectional view of an embodiment of a filter element for liquid filtration provided by the present disclosure;

FIG. 2 is an exploded view of the embodiment provided in FIG. 1;

FIG. 3 is a three-dimensional structural diagram of a ring seal in FIG. 1;

FIG. 4 is a sectional view of FIG. 3;

FIG. 5 is a sectional view of an embodiment of a filter element for liquid filtration provided by the present disclosure;

FIG. 6 is an exploded view of the embodiment provided in FIG. 5;

FIG. 7 is a sectional view of a partial structure of another embodiment of a filter element for liquid filtration provided by the present disclosure;

FIG. 8 is an exploded view of the embodiment provided in FIG. 7;

FIG. 9 is a sectional view of a partial structure of another embodiment of a filter element for liquid filtration provided by the present disclosure; and

FIG. 10 is an exploded view of the embodiment provided in FIG. 9.

In the drawings: filter element—100 for liquid filtration, ring filter medium—1, central cavity—11, first end cap—2, annular protrusion—21, closed end—211, buckle—22, second end cap—3, ventilation assembly—4, tubular body—41, connector—42, first ventilation hole—4a/4b, ventilation channel—4c, second ventilation hole—4d/4c, auxiliary hole—4f, ring seal—5, first sealing portion—51, second sealing portion—52, intercepting ring groove—53, central frame—6, oil—water separation medium—61, flow guide plate—62, third end cap—63, annular connecting end—64, third ventilation hole—5a, filter—1000, housing assembly—200, central tube—201, housing body—202, fuel inlet—202a, exhaust pipeline—202b, clean fuel pipeline—202c, drainage pipeline—202d, oil return pipeline—202e, screw cap—203, and locking piece—203a.

The objective achievement, functional characteristics, and advantages of the present disclosure will be further illustrated with reference to the accompanying drawings in conjunction with the embodiments.

### DETAILED DESCRIPTION OF THE INVENTION

The technical solutions in the embodiments of the present application are clearly and completely described below with reference to the accompanying drawings in the embodiments of the present application. Apparently, the described embodiments are merely some rather than all of the embodiments of the present application. All other embodiments obtained by those of ordinary skill in the art based on the embodiments of the present application without creative efforts shall fall within the scope of protection of the present application.

In order to better describe and illustrate the embodiments of the present application, one or more accompanying drawings may be referred to, but additional details or examples used to describe the accompanying drawings should not be considered to limit the scope of any one of creations, presently described embodiments, or preferred modes of the present application.

In the description of the present disclosure, it is to be noted that the orientations or positional relationships indicated by the terms “length”, “width”, “upper”, “lower”, “front”, “back”, “left”, “right”, “top”, “bottom”, “inside”, “outside”, etc. are based on the positional relationships shown in the accompanying drawings, only for the convenience of describing the present disclosure rather than indicating that the referred apparatus must have a particular orientation or be operated in a particular orientation, and therefore cannot be construed as a limitation to the present disclosure.

All technical and scientific terms used herein have the same meaning as commonly understood by those skilled in the art of this application, unless otherwise defined. The terms used in the specification of this application are only used for describing specific embodiments, and are not intended to limit this application.

In the patent of a liquid medium filter element with ventilation assemblies on a rear filtering side and a front filtering side, and a filter system (publication number: CN106975267A), a first ventilation channel fluidly connected to the front filtering side at an inlet end and a second ventilation channel fluidly connected to the rear filtering side at the inlet end are disclosed. In actual use, because an opening of the first ventilation channel is too large, uncleaned oil easily enters the first ventilation channel, resulting in degradation of the filtering performance; the second ventilation channel is bent and thus is easy to block by the oil, such that air on a clean side cannot be effectively discharged. Moreover, a sealing O-ring is used in the filter element. In order to enhance the sealing effect, a large amount of compression is generally adopted for interference fit. Meanwhile, oil dirt and impurities after oil filtration are settled at the sealing O-ring. Due to slurry settlement caused by long-time operation and compression for interference fit, the filter element is difficult to disassemble when replaced, and especially when the ventilation channel is not smooth, an internal negative pressure is formed during disassembly, such that the disassembly requires a larger force and is more laborious.

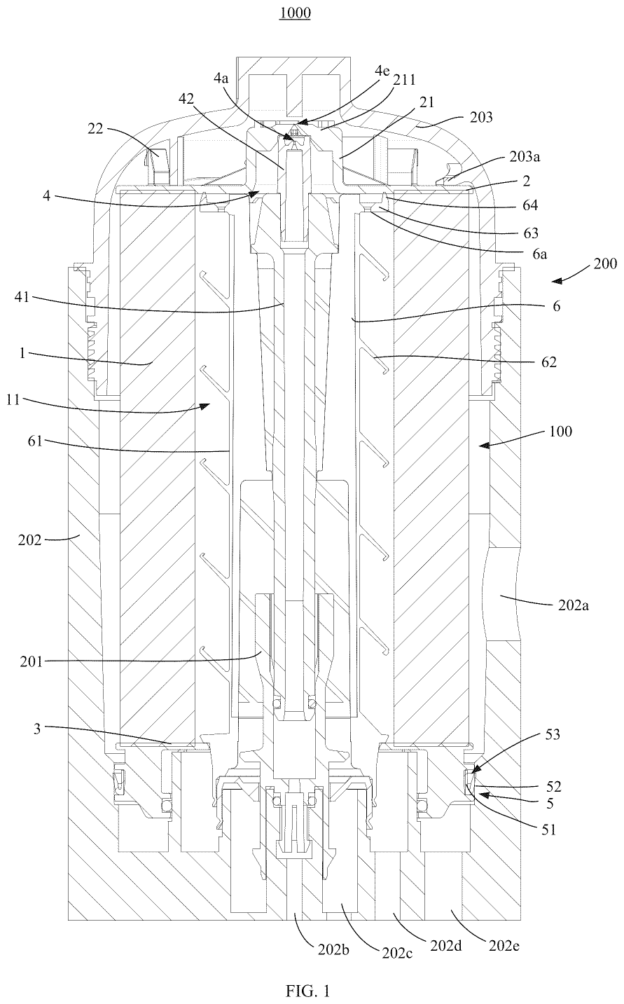

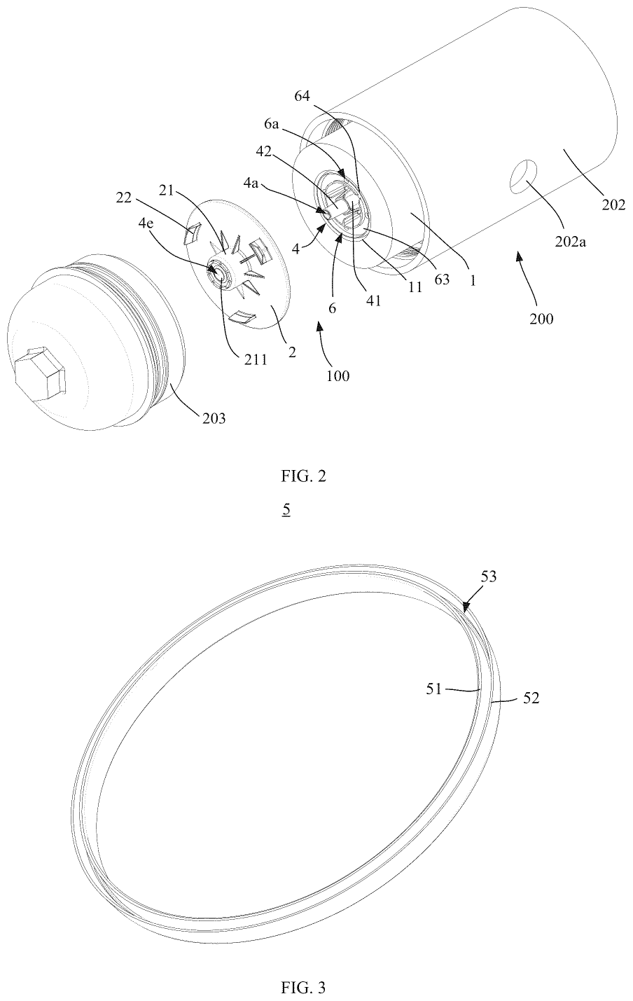

In view of this, the present disclosure provides a filter element for liquid filtration. FIG. 1 and FIG. 2 are embodiments of a filter element for liquid filtration provided by the present disclosure. The filter element is mounted in a filter assembly. Referring to FIG. 1 and FIG. 2, the filter element 100 for liquid filtration includes a ring filter medium 1, first and second end caps 2 and 3 connected to the ring filter medium 1, a ventilation assembly 4, and a ring seal 5.

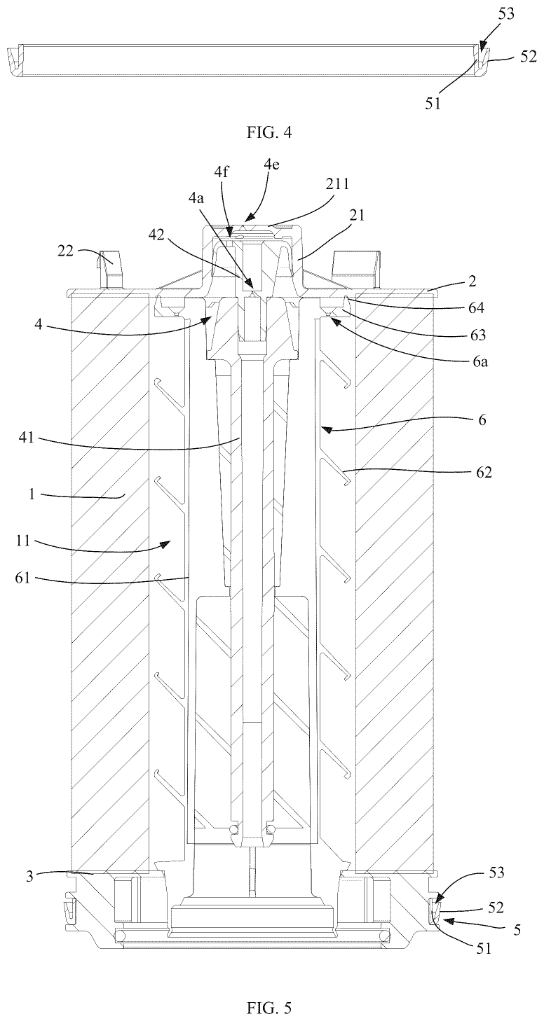

Specifically, the ring filter medium 1 has a central cavity 11 formed around a central axis thereof; and the ventilation assembly 4 is disposed in the central cavity 11 and has a first ventilation hole 4a communicated to an exhaust pipeline 202b from a clean side and a second ventilation hole 4c communicated to the exhaust pipeline 202b from a non-clean side. An inner side of the ring filter medium 1 is the clean side, and an outer side of the ring filter medium 1 is the non-clean side. The ventilation assembly 4 has a tubular body 41 communicated to a central tube 201 in a housing assembly 200 of a filter, and the central tube 201 is communicated to the exhaust pipeline 202b. It is to be noted that the first ventilation hole 4a may be formed on the tubular body 41 or another component of the ventilation assembly 4; and the second ventilation hole 4c may be formed on the ventilation assembly 4 or the first end cap 2. Referring to FIG. 3 and FIG. 4, the ring seal 5 includes a first sealing portion 51 hermetically connected to the second end cap 3 and a second sealing portion 52 hermetically connected to the housing assembly 200, where an intercepting ring groove 53 is formed at a joint between the first sealing portion 51 and the second sealing portion 52 for intercepting oil dirt and impurities settled after fuel filtration. The first scaling portion 51 is tightly connected to a peripheral edge of the second end cap 3, and the second sealing portion 52 is a compressible annular spring. When the filter element 100 is mounted, the second sealing portion 52 is compressed and hermetically connected to the housing assembly 200. A cross section of the ring seal 5 is approximately V-shaped, that is, the intercepting ring groove 53 is a V-shaped groove. Certainly, this embodiment of the present disclosure is not limited thereto, and the cross section of the ring seal 5 may also be in an N shape, a W shape, etc., which can be selected according to a usage environment of the filter element.

It is to be noted that the ring seal 5 in this shape has a thin-walled structure, is very soft, and can be designed to have a large deformation. When the filter element 100 is assembled, a soft thin wall will be naturally attached to an inner wall of a housing of the housing assembly 200 like a suction cup. Because a middle of the first sealing portion 51 and a middle of the second scaling portion 52 are not solid and formed with compression spaces, a force of attachment to the inner wall of the housing is not very large, and separation can easily occur. When the filter element 100 is in operation, the thin wall is pressed towards the inner wall of the housing under a pressure of oil. The higher the pressure is, the tighter the attachment is, and the better the sealing effect is, so the ring seal 5 has a self-sealing structure. After loss of the pressure, the force of attachment between the thin wall and the inner wall of the housing restores to a normal state.

In the technical solution of the present disclosure, air gathered on the clean side and the non-clean side of the filter element 100 passes through the first ventilation hole 4a and the second ventilation hole 4c of the ventilation assembly 4 respectively and is discharged into the exhaust pipeline 202b in the housing assembly 200 of the filter by the ventilation assembly 4. The designed small holes can enable the air to smoothly pass through and allow a very small amount of oil to pass through, are hard to block, and will not degrade the filtering performance of the filter element. In addition, a sealing O-ring at a sealing part of the filter element 100 and the housing assembly 200 is replaced with the ring seal 5 with a self-sealing function, which has a better scaling effect under a pressure difference and can reduce a compression amount; and the intercepting ring groove 53 is hard to block by oil dirt while settling the oil dirt, the replacement and disassembly of the filter element 100 are not affected, and especially under effective exhaust of the ventilation assembly, the disassembly is more labor-saving.

Referring to FIG. 1 and FIG. 2, in some embodiments of the present disclosure, in order to facilitate mounting of the tubular body 41, the ventilation assembly 4 includes a connector 42 connected to the first end cap 2 and the tubular body 41 separately. The connector 42 is connected to the first end cap 2, such that the ventilation assembly 4 can be connected to the first end cap 2. Moreover, the connector 42 is communicated with the tubular body 41. It is to be noted that the connector 42 is not restricted in shape and may be designed to be tubular, cap-shaped, etc., so as to communicate with the tubular body 41; and the connection between the connector 42 and the first end cap 2 may be an interference connection, a clamped connection, a glued connection, etc., which will not be described in detail here. In addition, the design of the connector 42 makes it convenient for the tubular body 41 of the ventilation assembly 4 to be produced and manufactured.

It is considered that the connector 42 can be used for connection and air exhaust. Referring to FIG. 1 and FIG. 2, in this embodiment, the first ventilation hole 4a is formed on the connector 42. Specifically, the connector 42 is tubular, one end of the connector is inserted into an opening at one end of the tubular body 41, the other end of the connector 42 is in clamped connection with the first end cap 2, the first ventilation hole 4a is formed on an end surface in a tube body of the connector 42, and the first ventilation hole 4a is communicated with the clean side of the filter element 100 and the tubular body 41 separately. After being gathered on the clean side, the air passes through the tubular connector 42 and the tubular body 41 in sequence from the first ventilation hole 4a, and then enters the exhaust pipeline 202b from the central tube 201. It is to be noted that the clean side here refers to the inside of the filter element 100, that is, to the central cavity 11.

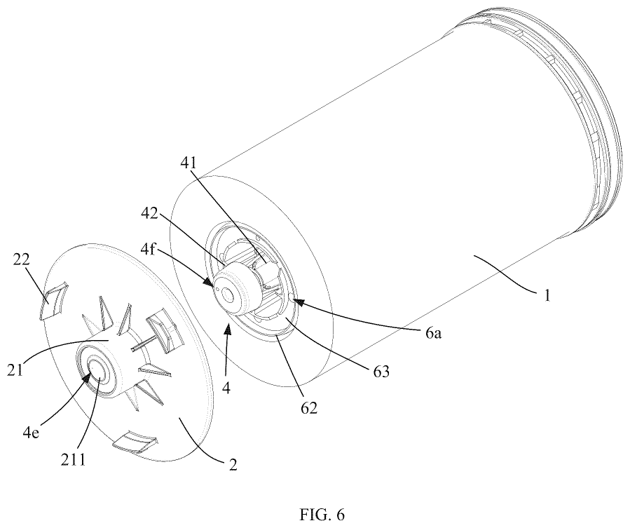

In some other embodiments, the connector 42 is also tubular, and the first ventilation hole 4a is formed on an end surface in a tube of the connector 42. Referring to FIG. 5 and FIG. 6, one end of the connector 42 is in interference connection with the first end cap 2, and the other end of the connector is inserted into the opening at one end of the tubular body 41. Due to the interference connection, the first ventilation hole 4a cannot be communicated with the clean side. An auxiliary hole 4f is formed on an end surface of an end part of the connector 42, such that the first ventilation hole 4a is communicated with the clean side (the central cavity 11) of the filter element 100 and the tubular body 41 separately, and the air in the clean side of the filter element 100 is discharged by the exhaust pipeline 202b.

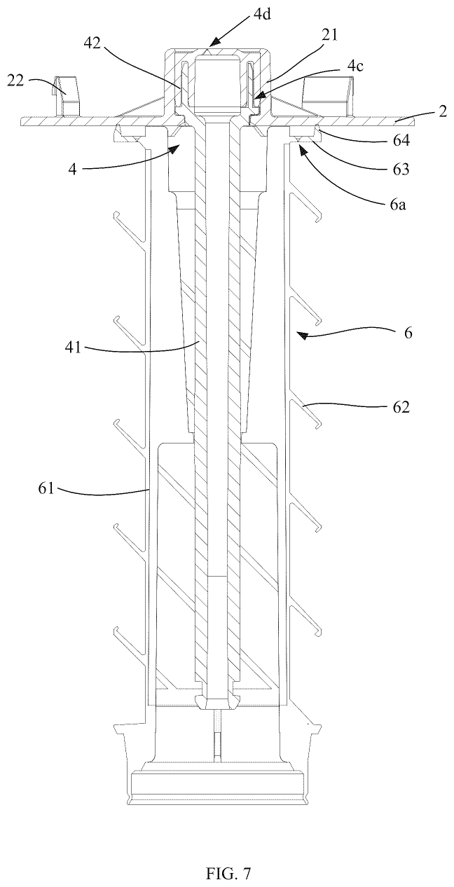

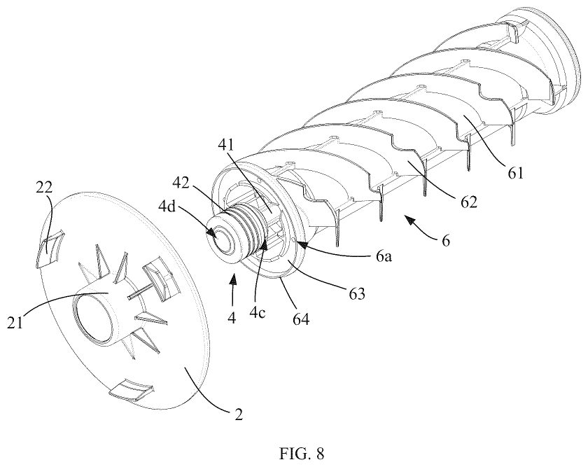

Certainly, the design of the present disclosure is not limited to this. Referring to FIG. 7 and FIG. 8, in some embodiments, the first ventilation hole 4b is formed on the tubular body 41 and is communicated with the clean side (the central cavity 11) of the filter element 100 and the tubular body 41 separately, and the air in the clean side of the filter element 100 is discharged by the exhaust pipeline 202b. It is to be noted that the position of the first ventilation hole 4b on the tubular body 41 should be as close as possible to the air gathering part.

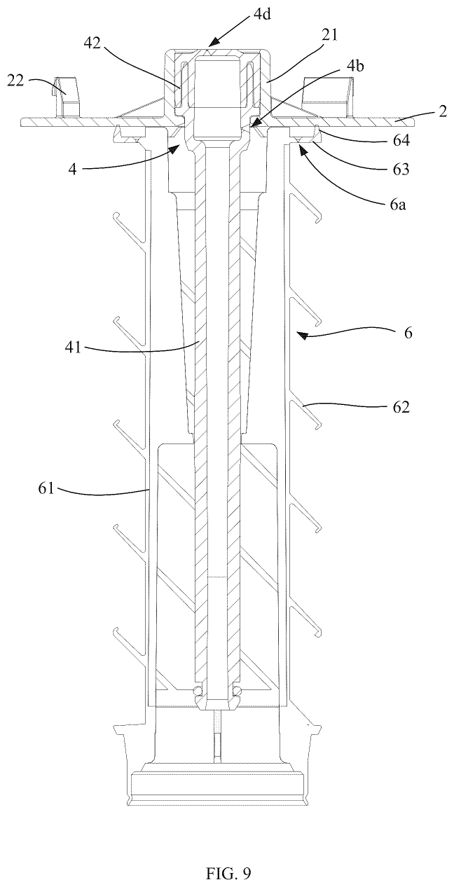

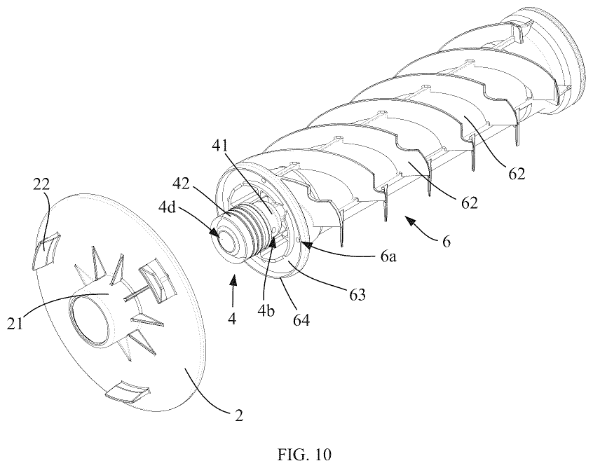

In addition, a form of channel may also be designed to replace the first ventilation hole 4b. Referring to FIG. 9 and FIG. 10, in an embodiment, the tubular body 41 is in interference connection with the connector 42, a ventilation channel 4c is formed at a joint between the tubular body 41 and the connector 42, the ventilation channel 4c is communicated with the clean side (the central cavity 11) of the filter element 100 and the tubular body 41 separately, and the air in the clean side of the filter element 100 is discharged by the exhaust pipeline 202b.

In order to facilitate mounting of the connector 42, referring to FIG. 1 and FIG. 2, in this embodiment, a middle of the first end cap 2 axially protrudes outward to form an annular protrusion 21, and the connector 42 is in clamped connection with an inner wall of the annular protrusion 21. Certainly, other connections may also be adopted. In some other embodiments, referring to FIG. 5 and FIG. 6, the connector 42 is in interference connection with the inner wall of the annular protrusion 21. In another embodiment, referring to FIG. 7 to FIG. 10, the connector 42 is in glued connection with the inner wall of the annular protrusion 21.

Further, the connector 42 is hermetically connected to the inner wall of the annular protrusion 21. Due to the fact that the air brought in from the fuel also gathers on the non-clean side of the filter element 100, in order to discharge the air, referring to FIG. 7 to FIG. 10, in these embodiments, a position where the middle of the first end cap 2 forms the annular protrusion 21 is formed with an opening, and a second ventilation hole 4d is formed on the end surface of the connector 42 and is configured to be communicated with the non-clean side and the tubular body 41, so as to discharge the air on the non-clean side.

Certainly, the design of the present disclosure is not limited to this. Referring to FIG. 1, FIG. 2, FIG. 5, and FIG. 6, in some embodiments, an inner sidewall of the annular protrusion 21 radially extends inward to form a closed end 211, and the closed end 211 is formed with the second ventilation hole 4d communicated to the tubular body 41 and configured to be communicated with the non-clean side and the tubular body 41, so as to discharge the air on the non-clean side.

It is to be understood that during use, a diameter of the first ventilation hole 4a/4b and a diameter of the second ventilation hole 4d/4e are controlled to be 0.3-0.6 mm. The diameter is selected to enable the air to quickly pass through and allow a small amount of the fuel to pass through. The too small diameter easily causes blockage and makes it impossible to quickly discharge the gathered air, while the too large diameter causes a large amount of the fuel to be discharged to bring about a fuel supply pressure loss and an insufficient fuel supply pressure. Accordingly, the diameter of 0.3-0.6 mm is just right. In addition, the first ventilation hole 4a/4b and the second ventilation hole 4d/4e are both bell mouths, have short hole channels, and are hard to block; and the diameter of the first ventilation hole 4a/4b is greater than the diameter of the second ventilation hole 4d/4c.

In some embodiments of the present disclosure, referring to FIGS. 1 to 4, the filter element 100 further includes a central frame 6, where the central frame 6 is disposed in the central cavity 11 and at a periphery of the ventilation assembly 4, and an oil-water separation medium 61 is circumferentially disposed on the central frame 6 for separating water from oil. A spiral flow guide plate 62 is further disposed at a periphery of the central frame 6. The flow guide plate 62 can guide the oil to flow and make it fully contact with the oil-water separation medium 61, thereby improving the water filtration performance and the filtration efficiency.

Further, two ends of the central frame 6 are hermetically connected to the first end cap 2 and the second end cap 3. Due to large resistance of the air passing through the oil-water separation medium 61, the air on the clean side of the filter element 100 cannot easily enter the first ventilation hole 4a/4b. Referring to FIGS. 1 to 4, in some embodiments, third ventilation holes 6a are formed on the central frame 6, such that the air gathered on the clean side can be guided into the central frame 6 and then enters the first ventilation hole 4a/4b.

Specifically, an outer sidewall of the central frame 6 radially extends outward to form a third end cap 63, a peripheral edge of the third end cap 63 axially extends outward to form an annular connecting end 64, and the annular connecting end 64 is hermetically connected to the first end cap 2; and the third ventilation holes 6a are formed on the third end cap 63 and are uniformly distributed circumferentially.

When the filter element 100 is mounted, the second end cap 3 is hermetically connected to the housing assembly 200, such that one end of the filter element 100 is relatively fixed. To fix the other end of the filter element, a buckle 22 is disposed on an end surface of the first end cap 2, and a locking piece 203a is disposed inside a screw cap 203 of the filter. Specifically, during the mounting and disassembly of the filter element 100, the filter element 100 is connected to the screw cap 203 by the buckle 22 and the locking piece 203a. The filter element has two mounting modes. In a mounting mode (1), the filter element 100 is first mounted in the screw cap 203 (by means of direct insertion or rotation), the buckle 22 is in snap fit with the locking piece 203a, and the filter element 100 and the screw cap 203 are together mounted in the housing by means of rotation. In a mounting mode (2), the filter element 100 is first mounted in a housing body 202, then the screw cap 203 is screwed on, and after mounting, the buckle 22 and the locking piece 203a are not necessarily be in a snap-fit state. During the disassembly, the screw cap 203 rotates, a hook part of the locking piece 203a enters a hook part of the buckle 22, and the filter element 100 is hooked and moved out after snap fit. During the process of moving out the filter element 100, the ring seal 5 is opened, and non-clean oil retained in the housing body 202 is discharged by an oil return pipeline 202c to complete emptying of the housing of the filter, thereby avoiding oil overflow when the filter element 100 is moved out of the housing body 202, and reducing excess oil brought out by the filter element 100. When moved out, the filter element 100 is always in a snap-fit and hooked state with the screw cap 203. Finally, the filter element 100 is manually rotated out of the screw cap 203 or directly pulled out.

The present disclosure further proposes a filter 1000, including the above filter element 100 for liquid filtration and a housing assembly 200, where the housing assembly 200 includes a housing body 202 and the screw cap 203 in threaded connection with each other, the central tube 201 is disposed inside the housing body 202, and the tubular body 41 is communicated with the central tube 201 till an exhaust pipeline 202b. A fuel inlet 202a is further formed on a side surface of a housing of the housing body 202, and a clean fuel pipeline 202c for pumping out oil from a clean side to an engine, a drainage pipeline 202d for draining water from the clean side to the outside, and an oil return pipeline 202e for recovering oil from a non-clean side to a fuel tank are disposed at a bottom of the housing.

The technical features of the above embodiments may be combined arbitrarily. For the sake of brevity, all possible combinations of the technical features in the above embodiments are not described. However, the combinations of these technical features should all be considered to be within the scope of this specification as long as there is no contradiction between them.

The above embodiments only express several implementations of this application and are described more specifically and detailedly, but they cannot be construed as a limitation to the scope of invention patent. It is to be pointed out that several modifications and improvements may also be made by those of ordinary skill in the art without departing from the conception of this application, and all fall within the scope of protection of this application. Therefore, the scope of patent protection of this application shall be subject to the appended claims.

What is claimed is:

1. A filter element for liquid filtration, comprising:
a ring filter medium, and a first end cap and a second end cap connected to the ring filter medium, wherein the ring filter medium has a central cavity formed around a central axis thereof;
a ventilation assembly disposed in the central cavity and having a first ventilation hole communicated to an exhaust pipeline from a clean side and a second ventilation hole communicated to the exhaust pipeline from a non-clean side; and
a ring seal comprising a first sealing portion and a second sealing portion which are hermetically connected to the second end cap and a housing assembly respectively, wherein an intercepting ring groove is formed at a joint between the first sealing portion and the second sealing portion.

2. The filter element for liquid filtration according to claim 1, wherein the ventilation assembly comprises a connector connected to the first end cap and a tubular body communicated to the exhaust pipeline in the housing assembly, and the connector is communicated with the tubular body.

3. The filter element for liquid filtration according to claim 2, wherein the first ventilation hole is formed in the connector or the tubular body.

4. The filter element for liquid filtration according to claim 2, wherein a ventilation channel is formed at a joint between the tubular body and the connector.

5. The filter element for liquid filtration according to claim 2, wherein the second ventilation hole is formed in the first end cap or the connector.

6. The filter element for liquid filtration according to claim 2, wherein a middle of the first end cap axially protrudes outward to form an annular protrusion, the connector is hermetically connected to an inner wall of the annular protrusion, and the second ventilation hole is formed in the connector.

7. The filter element for liquid filtration according to claim 2, wherein a middle of the first end cap axially protrudes outward to form an annular protrusion, an inner sidewall of the annular protrusion axially extends inward to form a closed end, and the second ventilation hole is formed in the closed end.

8. The filter element for liquid filtration according to claim 1, further comprising a central frame, wherein the central frame is disposed in the central cavity and at a periphery of the ventilation assembly, and an oil-water separation medium is circumferentially distributed on the central frame; and
a flow guide plate distributed in a spiral shape is disposed on a peripheral edge of the central frame.

9. The filter element for liquid filtration according to claim 8, wherein a buckle is disposed on an end surface of the first end cap, and the buckle is in clamped connection with a locking piece in a screw cap of a filter.

10. A filter, comprising: the filter element for liquid filtration according to claim 1; and
a housing assembly, wherein a central tube is disposed inside the housing assembly, and the ventilation assembly is communicated with the central tube till an exhaust pipeline.

11. A filter, comprising: the filter element for liquid filtration according to claim 2; and
a housing assembly, wherein a central tube is disposed inside the housing assembly, and the ventilation assembly is communicated with the central tube till an exhaust pipeline.

12. A filter, comprising: the filter element for liquid filtration according to claim 3; and
a housing assembly, wherein a central tube is disposed inside the housing assembly, and the ventilation assembly is communicated with the central tube till an exhaust pipeline.

13. A filter, comprising: the filter element for liquid filtration according to claim 4; and
a housing assembly, wherein a central tube is disposed inside the housing assembly, and the ventilation assembly is communicated with the central tube till an exhaust pipeline.

14. A filter, comprising: the filter element for liquid filtration according to claim 5; and
a housing assembly, wherein a central tube is disposed inside the housing assembly, and the ventilation assembly is communicated with the central tube till an exhaust pipeline.

15. A filter, comprising: the filter element for liquid filtration according to claim 6; and
a housing assembly, wherein a central tube is disposed inside the housing assembly, and the ventilation assembly is communicated with the central tube till an exhaust pipeline.

16. A filter, comprising: the filter element for liquid filtration according to claim 7; and
a housing assembly, wherein a central tube is disposed inside the housing assembly, and the ventilation assembly is communicated with the central tube till an exhaust pipeline.

17. A filter, comprising: the filter element for liquid filtration according to claim 8; and
a housing assembly, wherein a central tube is disposed inside the housing assembly, and the ventilation assembly is communicated with the central tube till an exhaust pipeline.

18. A filter, comprising: the filter element for liquid filtration according to claim 9; and
a housing assembly, wherein a central tube is disposed inside the housing assembly, and the ventilation assembly is communicated with the central tube till an exhaust pipeline.
